(19) United States
(12) Patent Application Publication
(10) Pub. No.: US 2009/0319993 A1
(43) Pub. Date: Dec. 24, 2009

(54) GENERALIZED AND EXTENSIBLE SOFTWARE ARCHITECTURE REPRESENTATION

(75) Inventors: Allen Wayne Denver, Mililani, HI (US); Mohsen Agsen, Honolulu, HI (US); Craig Joseph Symonds, Honolulu, HI (US); Jacob Meyer, Redmond, WA (US); Scott Marison, Honolulu, HI (US)

Correspondence Address: MICROSOFT CORPORATION, ONE MICROSOFT WAY, REDMOND, WA, 98052, US

(73) Assignee: MICROSOFT CORPORATION,, Redmond, WA (US)

(21) Appl. No.: 12/144,654

(22) Filed: Jun. 24, 2008

(51) Int. Cl. G06F 9/44

(52) U.S. Cl. 717/121

(57) ABSTRACT

Software architectures may include many types of elements, such as classes, functions, databases, queries, and users. An architecture may be the subject of many types of analysis, such as discovery of architecture features and design choices, rendering according to (e.g.) a visual layout or as a hierarchical data set, validation and testing of a chosen design, and evaluation by systems analysis tools. However, the information documenting the software architecture is often organized in a disjointed manner, such as in a set of release documentation, inline comments in source code, notes recorded in version control systems, and contact databases. Instead, the software architecture may be represented as a set of nodes of various node categories interconnected by links of different types. The representation may then be utilized in many types of analysis, such as visualization, transformation, and element analysis by complex systems analysis tools.

### BACKGROUND

Contemporary software projects are often designed as a set of interoperating elements. For example, an application may involve a class that formulates a query, a remote service that manages a database and returns a result data set, and a graphical window class that displays the results of the query through a user-friendly interface. Moreover, a broader view of the “elements” of the software project may include individuals, such as users, software developers, and people who are represented in the software environment (e.g., customers represented in a business database.) These elements may interoperate in many ways in the performance of the project; for example, various modules written by two different teams of developers may be compiled by a compiler into two classes that exchange various types of data (e.g., in a client-server manner) on behalf of different classes of users.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

The software architecture of a project may be of interest for various reasons. As a first example, software developers involved in the project may wish to visualize and analyze the structure of the application and the interrelationships of its various elements, e.g., to validate the software design or to identify aspects for debugging or the addition of new features. As a second example, software engineers may wish to study the design of one or more projects, e.g., to identify a design pattern or architectural configuration chosen by a team of developers for a particular task.

However, the analysis of a software project may be obstructed by the disjointed storage of information about the architecture of the project. For example, a particular class may be documented in inline comments within the source code; the interrelationships and interaction of various classes may be described in a human-readable document, such as a set of release notes; and the architecture of the project may be documented in an organizational drawing (e.g., a set of UML diagrams.) The low degree of consistency among the various sources of documentation of a software architecture may limit the analysis of the software project, and may greatly diminish the prospect and scope of a comparative study of architectures of various software projects.

An alternative technique for documenting a project involves the representation of the software architecture as a graph comprising a set of interrelated nodes, where the nodes represent various types of elements (e.g., classes, objects, services, databases, devices, and individuals) and the relationships are documented as fitting into various categories (e.g., containment, specialization, and interactions of various elements.) A software project represented in this manner may be evaluated by many types of software engineering tools, e.g., a discovery tool that identifies the design patterns of the project, an analysis tool that evaluates the structure of the project, and a visualization tool that presents the layout of the architecture for easier understanding. Moreover, the documenting of many software architectures in this manner may permit a broad-scale comparative survey of software engineering techniques, such as the prevalence and uses of design patterns, and a functional analysis of the interaction of many software elements in a complex system. Finally, various actions pertaining to the software architecture may be more generally modeled (e.g., a build action may be represented as a “compile” action performed on the class nodes of the software architecture), and may be associated with one or more providers (including custom providers associated with the representation through a pluggable extensibility interface) that may carry out the actions upon request.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario involving the development of a software project with interoperating elements.

FIG. 2 is an illustration of a software project modeled as a node set comprising nodes that represent the various elements of the software project.

FIG. 3 is a flow chart illustrating an exemplary method of representing a software architecture.

FIG. 4 is a component block diagram illustrating an exemplary system for representing a software architecture.

FIG. 5 is an illustration of a representation portion of a software project comprising the project class and class library and the contained methods of these elements.

FIG. 6 is an illustration of an exemplary transformation of a representation of a software project to reflect an update of the software architecture.

FIG. 7 is an illustration of two exemplary renderings of a software project based on two visual layouts in a visual layouts set.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Software projects are often designed as a collection of elements configured to interoperate in the performance of a task. Object-oriented techniques may be employed in designing methods of instructions that are packaged in a class alongside encapsulated member objects and variables, and various class instances may cooperate to achieve a desired result. Such class instances may also interact with other elements of the project, e.g., databases, devices, work items such as queries and data sets, assemblies and various types of code libraries, and local and remote services. An even broader view of the elements of the software project may include various individuals, such as software developers, users of the software, and people represented in the software project (e.g., business clients represented as part of a commercial software package.)

Together, these cooperating elements comprise the software architecture. The design of the software predominantly involves the selection and interaction of such elements to provide the capabilities of the software project. For example, the manner in which work flows through a system may be modeled using design patterns, which comprise templates for common scenarios arising in various types of software projects. The design choices that result in the architecture may have an impact on the efficiency, flexibility, and usability of the software project. For example, in a distributed work-item processing project, a centralized distributor of work items may present improved coordination and tracking, while a decentralized solution may improve the scalability of the project.

The architecture of a software project may be useful in many ways. Developers of the software project may use the architecture information in the further design of the project, such as in debugging or implementing new features. Analysts may study the architecture to validate the choices of software design, and to devise changes that may support improved performance or the addition of new features. The details of the software architecture may also be useful in evaluating the consumption of other software elements (e.g., the degree of reliance of the software architecture on software libraries or resources, or the interaction of the software project with other services.) For example, software engineers may wish to evaluate the details of the software architecture as evidence of the existence and prevalence of various design choices in practice, which may support observations of new aspects of software design, such as new design patterns or programming methodologies (e.g., aspect-oriented programming.)

However, the evaluation of such information may be complicated by the disparate sources of information about the software architecture. In order to determine the architecture of the software project, a researcher, user, developer, or analyst may have to examine many sources of information associated with the various types of elements, and may have to piece together an understanding of the architecture. For a complex system involving many dissimilar but cooperating software projects and elements (such as an information technology system of a large institution), many researchers may have to research the various projects and manually assemble a map of the elements and a model of the interactions thereof. In some cases, such research may not even be possible (e.g., where a compiled binary representing a long-used software component is undocumented and the source code is unavailable.)

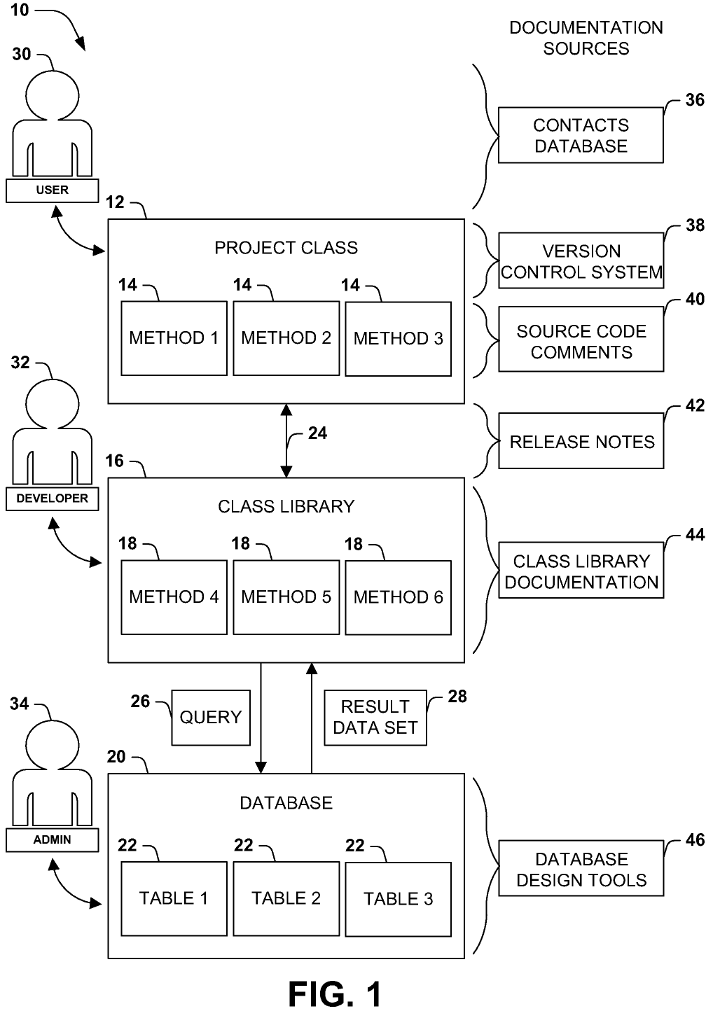

FIG. 1 illustrates an exemplary scenario 10 involving a software project with some interoperating elements. The software project involves a project class 12, comprising a set of methods 14 for performing various tasks of the software project. The software project also relies on a class library 16 having some class library methods 18 representing general functions that may be invoked by many such projects, and a database 20 having a set of data tables 22. The architecture of the software project involves all of these elements, as well as the interaction of the components, e.g., the utilization 24 of the class library 16 by the project class 12, and the interfacing of the class library 16 with the database 20 (e.g., the sending of a query 26 from the class library 16 to the database 20 and the returning of a result data set 28 from the database 20 to the class library 16.) The software architecture also includes the user 30 of the software project, the developer 32 of the class library 16, and the administrator 34 of the database 20.

In this exemplary scenario 10, an analyst wishing to understand and evaluate the architecture of the software project may have to examine a wide set of documentation sources. For example, the architecture of the project class 12 may be stored and documented in a version control system 38, while the structure and configuration of a particular method 14 of the project class 12 may be specified as inline source code comments 40 for each method 14. The manner of interfacing the project class 12 with the class library 16 may be set forth in a set of human-readable release notes 42 provided with the project class 12 (which may have been authored by a documentation team.) The architecture of the class library 16 may be described in human-readable class library documentation 44, and the architecture of the database 20 may be explored through the database design tools 46. Information about the individuals who operate such elements (e.g., the set of users of the project class 12) may be contained in a contacts database 36. Moreover, some parts of the software project may be simply undocumented (e.g., the manner in which the class library 16 queries the database 20 might not have been written up as a formal description in any data source, or the documentation might have been lost), and may be retrieved only through decompiling and reverse-engineering.

As a result of this disjointed set of information sources describing the software architecture of this project, analysis may be difficult. An analyst may have to study each documentation source, build an understanding of the scope, nature, and processes of each element, and formulate (by hand) a map of the software architecture and a description of the flow of data through the system. This may be difficult even for the simple software project illustrated in the exemplary scenario 10 of FIG. 1, but larger-scale projects (such as the information technology of an entire institution, such as a factory assembly plant) may simply be so large and complex that a human-mediated analysis of the architecture may be untenable. In some ways, these scenarios are similar to attempts to analyze other complex systems of interrelated components (e.g., biological ecosystems, weather patterns, environmental systems, and the molecular biology of various organisms.) These complex problems are often evaluated through the application of complex systems tools that can evaluate large bodies of interrelated components (e.g., proteins and genetic sequences involved in a biological pathway) and establish connections and quantify parameters. However, such tools can only be utilized on information captured as a standardized information set, i.e., if the elements of such complex systems can be represented as interrelated objects that together model the complex system.

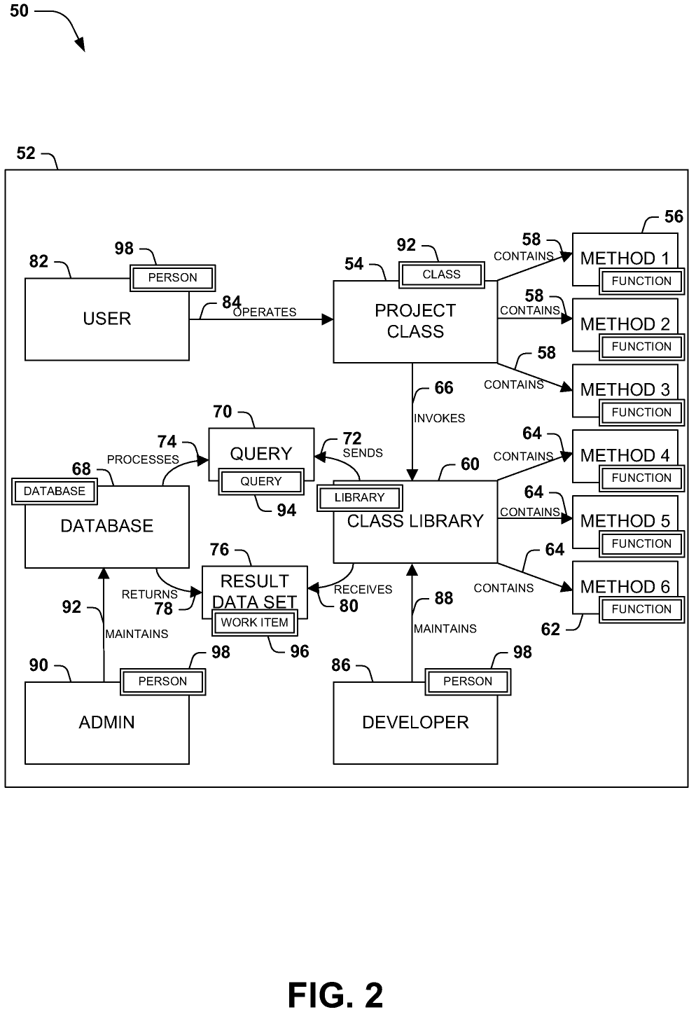

In furtherance of this modeling and other techniques of evaluation, FIG. 2 illustrates an exemplary modeling 50 of the software project illustrated in FIG. 1, wherein such modeling comprises a representation of the software architecture as a node set 52 comprising nodes that represent the various elements of the software project. The nodes of the node set 52 are of many types, including classes and instances thereof, units of data, resources, and individuals. Moreover, the nodes are interconnected through links that represent the relationships therebetween. The node set 52 in this exemplary scenario 50 includes a class project node 54 and various method nodes 56 embedded in the project class, and the project class node 54 is associated with the respective method nodes 56 with a “contains” link 58. The class library is also represented as a class library node 60 that is associated with method nodes 62 representing the methods of the class library 60 through a series of “contains” links 64, and is in turn associated with the project class node 54 through an “invokes” link 66. The class library node 60 also interfaces with a database node 68 through a “sends” link 72 associated with a query node 70 representing the query sent to by the class library to the database. The database node 68 is therefore associated with the query node 70 through a “processes” link 74, and is also associated with a result data set node 76 through a “returns” link 78 that is returned to the class library; accordingly, the result data set node 76 is also associated with the class library node 60 through a “receives” link 80. The individuals involves in the elements of this software architecture are also represented: the project class node 54 is associated with a user node 82 through an “operates” link 84; the class library node 60 is associated with a developer node 86 through a “maintains” link 88; and the database node 68 is associated with an administrator node 90 through a “maintains” link 92. Each such node may include a wide array of specialized details (e.g., the project class 54 may contain information about the compiling tools used to assemble the software binary and cryptographic signature information, while the user node 82 may include a name and email address for the user.) Moreover, each node may be associated with a node category to facilitate categorization of the nodes. For example, the project class node 54 may be associated with a “class” node category 92; the query node 70 and the result data set node 76 may be associated respectively with a “query” node category 94 and a “work item” node category 96; and the individuals may be associated with a “person” node category 98.

This node set 52 represents the elements of the software project and the interrelationships thereof. This representation may be used to analyze the architecture of the software project in many ways. For example, the visual layout of the node set 52 may be useful for understanding the flow of dependencies and interactions. The numbers and types of the nodes may be used to enumerate the different types of resources consumed by the software architecture. Analysts may consider the factoring of the project (e.g., the organization of methods among the various classes, and the location and contents of resources used by different components) in order to validate the sufficiency of the software architecture for various usage scenarios. Researchers may examine the interrelationships of components to evaluate the uses and usages of various design patterns. For complex projects modeled in this manner, complex systems analysis tools may be utilized to evaluate various aspects of the software architecture (e.g., by simulating a flow of a unit of data through the system and assessing the components involved in the processing thereof.) These and other analyses may be performed on this representation of the software architecture, and in a more automated and comprehensive manner, than on a more conventional and disjointed representation, such as illustrated in FIG. 1.

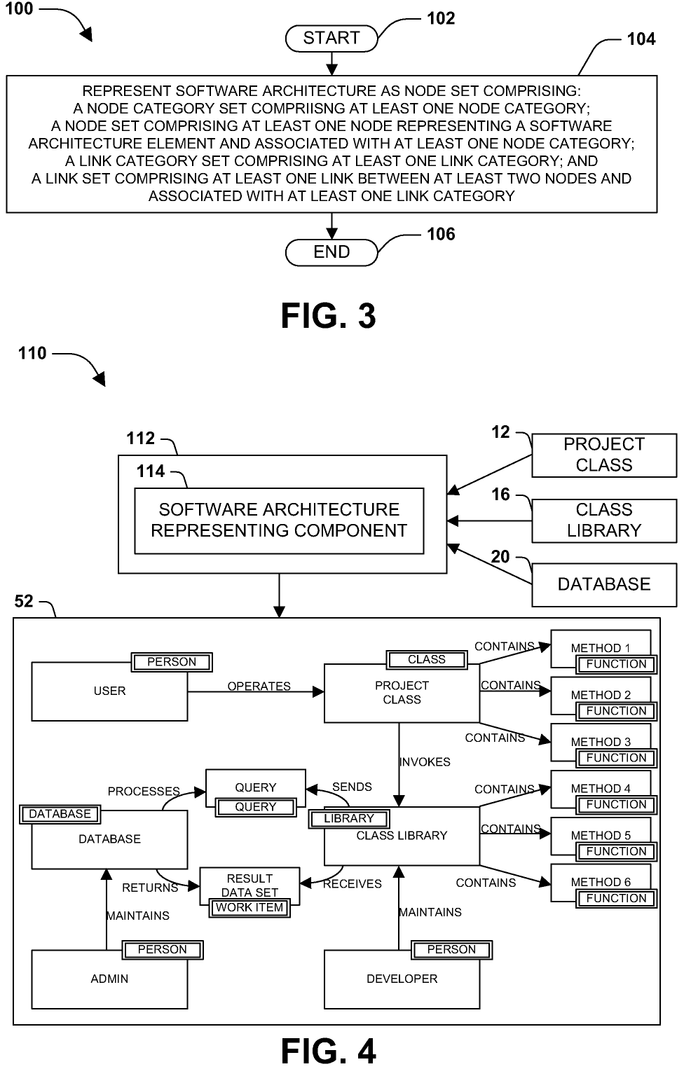

FIG. 3 illustrates a first embodiment of these techniques, comprising an exemplary method 100 of representing a software architecture. The exemplary method 100 begins at 102 and involves representing 104 the software architecture as a node set comprising (at least) four types of elements: nodes, node categories, links, and link categories. More specifically, the node set comprises a node category set comprising at least one node category; a node set comprising at least one node representing a software architecture element and associated with at least one node category; a link category set comprising at least one link category; and a link set comprising at least one link between at least two nodes and associated with at least one link category. Having provided a representation of the software architecture as a set of interrelated nodes, the exemplary method 100 thereby achieves the representing of the software architecture, and so ends at 106.

FIG. 4 illustrates a second embodiment of these techniques, comprising an exemplary scenario 110 featuring an exemplary system 112 for representing a software architecture. In this exemplary scenario 110, the exemplary system 112 is tasked with modeling the elements of the software project illustrated in FIG. 1, including the project class 12, the class library 16, and the database 20. The exemplary system 112 therefore features a software architecture rendering component 114 configured to represent the software architecture as a node set comprising (at least) four types of elements: nodes, node categories, links, and link categories. More specifically, the node set comprises a node category set comprising at least one node category; a node set comprising at least one node representing a software architecture element and associated with at least one node category; a link category set comprising at least one link category; and a link set comprising at least one link between at least two nodes and associated with at least one link category. For example, the software architecture representing component 114 may contain defined sets of node categories (e.g., class, individual, database, and individual) and link categories (e.g., contains, sends, and receives), formulate a set of nodes to represent the elements of the software architecture (each node having at least one node category), and formulate links therebetween to represent the interrelationships of the elements (each link having at least one link category.) The software architecture representing component 114 therefore produces a node set 52 representing the elements of the software project (such as the exemplary software architecture illustrated in FIG. 1), and thereby achieves the representation of the software architecture.

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 100 of FIG. 3 and the exemplary system 112 of FIG. 4) to confer individual and/or synergistic advantages upon such embodiments.

A first aspect that may vary among embodiments of these techniques relates to the details of the node set. The exemplary embodiment illustrated in FIG. 3 illustrates a node set comprising a set of nodes respectively representing elements and associated with a node category, interconnected by a set of links respectively associated with a link category. As a first example, the node categories may comprise (e.g.) a class node category for nodes representing classes and/or class instances; a function node category for nodes representing methods stored in classes; a parameter node category for parameter nodes provided to a method; a work item node category for work items flowing through the software architecture; an assembly node category for assemblies generated from other software components; a library node category for libraries of stored functions; a person node category for individuals, such as developers and users, who participate in the software architecture; a query node category for queries sent to databases; a database node category for databases; and a service node category for local and remote services. Other embodiments may feature other sets of node categories, and may permit associations of nodes with more than one node category; e.g., a node representing a remote database may be identified as both a service node and a database node.

As a second example of this first aspect, the link categories may comprise (e.g.) a “contains” link category for nodes encapsulating other nodes; an “invokes” link category for nodes that rely on other nodes; a “maintains” link category for nodes responsible for administrating and securing other nodes; “receives” and “sends” link categories for data types flowing between components; and an “operates” link category for illustrating a controlling/controlled relationship between two nodes. Other embodiments may feature different sets of link categories illustrating other types of relationships (e.g., trinary or higher-order relationships, such as “node X sends node Y to node Z.”) In some embodiments, the links may also be directed in various ways; e.g., the links illustrated in FIG. 2 are unidirectional relationships from a source node to a target node, but other embodiments may alternatively or additionally permit bidirectional or undirected links. Those of ordinary skill in the art may devise many variations in the representation of the software architecture while implementing the techniques discussed herein.

A second aspect that may vary among implementations of these techniques relates to the manner of generating the representation. The representation may be generated as a data set by one or more analysts who may seek to formulate a regular, well-formatted representation of the software architecture, and may utilize design and modeling tools to facilitate the configuration of the data representing the node set. For example, a visual design tool may be devised that facilitates a user in visually organizing the node set according to some visual semantic relationships (e.g., a link-drawing tool may permit the user to specify a link between a source node and a target node by drawing a line between two displayed nodes.) In another embodiment, a software architecture analysis tool may be utilized to generate part or all of the representation in an automated manner, e.g., by evaluating the organization of components specified in a source code or a compiled binary, or by monitoring the functioning of the elements of the software project during simulated or actual operation. Other tools may attempt to utilize some of the disjointed data sources to derive architecture information (e.g., by evaluating the order of commands in a makefile for building a project, the resources identified in an application configuration file, or the metadata stored in a version control system defining the organization of the software architecture.) A hybrid approach may also be taken, involving analysts who use various analysis tools to detect various aspects of the organization and interrelationships of the software components, and thereby elucidate the structure of the software architecture. Those of ordinary skill in the art may devise many approaches to elucidating of the organization and interrelationships of elements while generating a representation of the software architecture according to the techniques discussed herein.

Additional aspects of implementations of these techniques relate to additional functions that may be included in the representation of the software architecture. It may be appreciated that the techniques discussed herein predominantly relate to the discovery and representation of the software architecture, where such representation may be utilized by other resources (e.g., automated software architecture evaluation tools) and according to many other techniques. The representation may comprise many forms, and may include many additional elements that may also be utilized in relation to the software architecture.

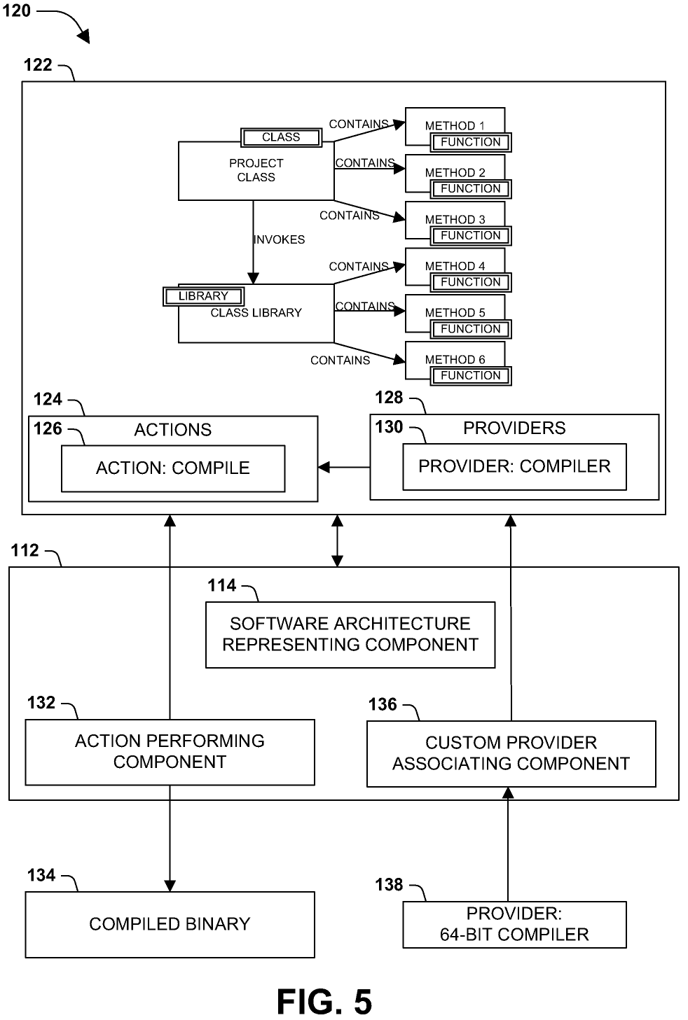

A third aspect that may vary among implementations of these techniques relates to the inclusion, in the representation, of actions that may be performed involving the nodes of the node set. In addition to the ordinary cooperative operation of the nodes of the node set, many types of actions may be performed using the represented model of the software architecture. For example, it may be desirable to create a mailing list for publishing news of updates to the software architecture, so the nodes representing individuals may be selected and used to generate a list of recipients who may be interested in such news. As another example, a diagnostic or maintenance tool may send a request to the represented elements to perform a diagnostic or maintenance task, and may therefore utilize the representation to identify the elements of the software architecture to be tested or administrated. These actions may be viewed as part of the software architecture, and may be formally represented within the node set as a set of actions that may be performed. FIG. 5 illustrates an exemplary scenario 120 involving a representation portion 122 of the representation of the software project more fully illustrated in FIG. 1, wherein the representation portion 122 comprises the project class and class library and the contained methods of these elements. The representation portion 122 may also include an actions set 124, comprising one or more actions 126 that may be invoked with reference to the software architecture. For example, an action 126 representing a “compile” command may be included in the representation that specifies a procedure for building a compiled binary 134 from the software elements of the representation (e.g., by compiling the project class, compiling the class library, linking the assembled project class to the assembled class library, and writing the compiled binary 134.) Moreover, an action may specify at least one node criterion specifying a subset of nodes with which the action is involved (e.g., generating an administrators' email list may involve retrieving the email addresses of nodes that are associated with an “individual” node category, and that have a “maintains” relationship with at least one other node.)

Accordingly, as one variation of this aspect, the actions may simply be included in the representation to document some performable actions involving at least one node of the node set. The information may then be used by external tools (e.g., a development suite that utilizes the action as a makefile) to perform the actions. As another variation of this aspect, the representation may include a providers set 138 comprising one or more providers 130 that are capable of performing an action on the node set. For example, a representation may include a set of compilers for different languages (e.g., a C++ compiler, a Java compiler, and an SQL query compiler.) An action may specify a particular provider that may be invoked to perform an action (e.g., “compile these modules with the C++ compiler provider”), and/or the providers may specify the capabilities thereof so that an appropriate provider may be selected for a particular action by an external tool. As a third variation of this aspect, the representation may facilitate the performing of the actions; e.g., and as illustrated in FIG. 5, the actions may be invoked by an action performing component 132 included in the exemplary system 112. Upon receiving a request to perform an action (such as an action 126 to generate a compiled binary 134), the action performing component 132 may initiate the action by identifying a provider capable of performing the action (such as the compiler 130 included in the representation portion 122) and performing the action involving the at least one node through the provider (such as by invoking the compiler 130 to compile the classes and methods of the software project.) In this manner, embodiments of these techniques (such as the exemplary system 112 of FIG. 5) may not only further document the software architecture with the inclusion of performable actions and providers, but may be operated to perform the actions by invoking the appropriate providers.

An additional variation of this aspect involves the extensibility of the representation, wherein a user, such as a developer, may specify the inclusion of new providers that support new actions (e.g., a logging provider for attaching monitors during the operation of the software architecture) or for performing actions in new ways (e.g., a 64-bit compiler that operates alongside a 32-bit compiler to generate assemblies for different hardware architectures.) The exemplary system 112 of FIG. 5 may therefore be extended by including a custom provider associating component 136 that may be configured, upon receiving a custom provider, to include the custom provider in the node set. For example, the custom provider associating component 136 may receive a request to add a 64-bit compiler 138 to the providers set 128, and may therefore associate the 64-bit compiler 138 with the providers set 128 in order to facilitate the generation of 64-bit assemblies. Those of ordinary skill in the art may devise many ways of performing actions on the nodes of the node set representing the software architecture in accordance with the techniques discussed herein.

A fourth aspect that may vary among implementations of these techniques relates to the transformation of the representation. The node set may be modified in many ways to alter the representation, e.g., to broaden the scope of the representation by including new elements (such as new users), or to add detail to the represented elements of the software architecture. The node set may also be transformed to retain synchrony with the represented software architecture, e.g., while the software architecture is further developed with the addition, modification, or removal of various elements and/or interrelationships. Accordingly, embodiments of these techniques may be configured to transform the node set upon request; e.g., the exemplary system 112 of FIG. 4 may include at least one transforming component 144 configured, upon receiving a request to transform the software architecture, to transform at least one node of the node set 112.

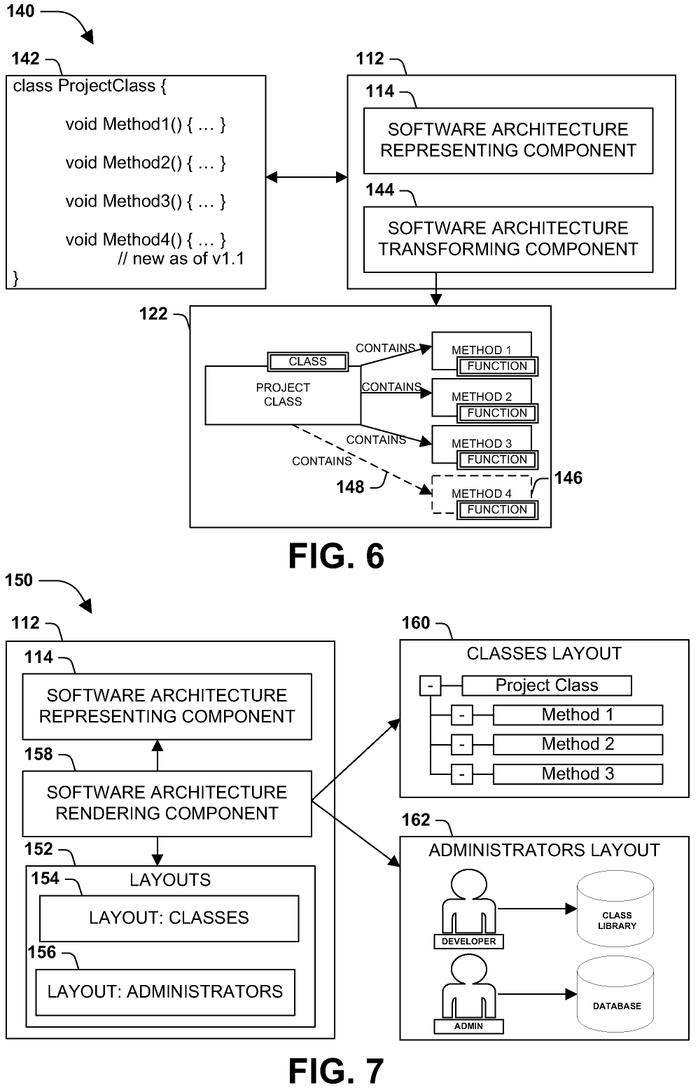

FIG. 6 illustrates an exemplary scenario 140 wherein the request comprising detecting an update of the software architecture, and wherein the transforming comprises transforming the node set to reflect the update of the software architecture. The software project may involve a source code module 142 for the project class of the software architecture, and that specifies the methods of the project class. During the continued development of the project class, a developer may add a new method (e.g., Method 4) to a new version of the software architecture, and the representation previously generated may not reflect the added method. Accordingly, the exemplary system 112 includes a software architecture transforming component 144 that receives and handles requests to transform the node set; e.g., the software architecture transforming component 144 may monitor and detect changes to the underlying software architecture, and may accordingly transform the node set. As illustrated in FIG. 6, the software architecture transforming component 144 may detect a change in the source code module 142 for the project class, may analyze the contents of the new source code and detect the new method, and may update the representation (illustrated as a representation portion 122 of the software architecture more fully illustrated in FIG. 1) by adding a new method node 146 representing “Method 4,” and by adding a new link 148 associating the “Method 4” node with the project class node, wherein the new link 148 is associated with a “contains” link category. The updated representation portion 122 now reflects the update to the latest version of the software architecture. Those of ordinary skill in the art may devise many ways of transforming the node set representing the software architecture according to the techniques discussed herein.

A fifth aspect that may vary among implementations of these techniques relates to the rendering of the representation according to many rendering types. It may be appreciated that the rendering of the software architecture comprises the elucidation of a graph of interconnected nodes representing the elements of the software architecture, and that the representations illustrated in the figures included herein (such as the exemplary modeling 50 of FIG. 2) represent but one manner of visually rendering the representation. Once represented in the manner discussed herein, the node set may be rendered in many ways to facilitate many types of analysis; and upon receiving a request to render at least a portion of the software architecture, an embodiment of these techniques may render at least one node of the node set. As one example, the representation may be rendered as a hierarchical data set, such as a relational database or an XML-formatted document that defines the elements of the software architecture and the interrelationships therebetween. As another example, the representation may be visually rendered, whereby particular elements may be spatially arranged according to various layout semantics. As one such example, the node set may comprise at least one visual layout specifying a visual configuration of at least one node of the node set, and the request may specify at least one visual layout for rendering the portion of the software architecture (e.g., a first visual layout specifying how classes and methods are to be displayed, and a second visual layout specifying how users are visually represented.) An embodiment may therefore handle the request by visually rendering the at least one node of the node set according to the at least one specified visual layout. Moreover, an embodiment may be capable of rendering the representation in many ways based on the details of different rendering requests in order to facilitate different types of analysis (e.g., a visual or human-readable rendering for analysts and a hierarchical data set rendering conforming to various schemata for consumption by complex systems analysis tools.)

FIG. 7 illustrates an exemplary scenario 150 wherein the exemplary system 112 comprises a visual layouts set 152 comprising two visual layouts: a first visual layout 154 specifying a manner of spatially organizing classes and contained methods, and a second visual layout 156 specifying a manner of spatially organizing administrators. The exemplary system 112 also comprises a software architecture rendering component 158, which is capable of rendering the representation of a software architecture (such as the software architecture and representation thereof illustrated in FIG. 2) according to the visual layouts. For example, upon receiving a request to render the classes and methods of the representation according to the first visual layout 154, the software architecture rendering component 158 may evaluate the node set and generate a first visual representation 160 illustrating the classes and methods as a hierarchical tree; and upon receiving a request to render the administrators and administrated resources according to the second visual layout 156, the software architecture rendering component 158 may evaluate the node set and generate a second visual representation 162 comprising icons representing different individuals and the resources for which such individuals are administratively responsible. Those of ordinary skill in the art may devise many ways of rendering the representation of the nodes of the node set representing the elements of the software architecture according to the techniques discussed herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

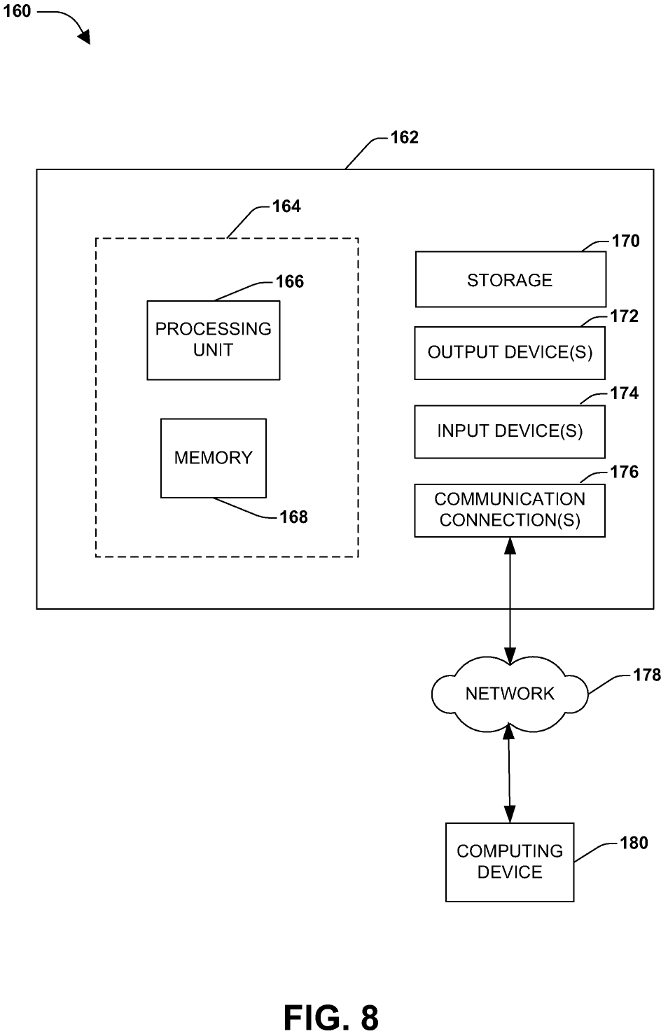

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 160 comprising a computing device 162 configured to implement one or more embodiments provided herein. In one configuration, computing device 162 includes at least one processing unit 166 and memory 168. Depending on the exact configuration and type of computing device, memory 168 may be volatile (such as RAM, for example), non-volatile (such as ROM, flash memory, etc., for example) or some combination of the two. This configuration is illustrated in FIG. 8 by dashed line 164.

In other embodiments, device 162 may include additional features and/or functionality. For example, device 162 may also include additional storage (e.g., removable and/or non-removable) including, but not limited to, magnetic storage, optical storage, and the like. Such additional storage is illustrated in FIG. 8 by storage 170. In one embodiment, computer readable instructions to implement one or more embodiments provided herein may be in storage 170. Storage 170 may also store other computer readable instructions to implement an operating system, an application program, and the like. Computer readable instructions may be loaded in memory 168 for execution by processing unit 166, for example.

The term “computer readable media” as used herein includes computer storage media. Computer storage media includes volatile and nonvolatile, removable and non-removable media implemented in any method or technology for storage of information such as computer readable instructions or other data. Memory 168 and storage 170 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 162. Any such computer storage media may be part of device 162.

Device 162 may also include communication connection(s) 176 that allows device 162 to communicate with other devices. Communication connection(s) 176 may include, but is not limited to, a modem, a Network Interface Card (NIC), an integrated network interface, a radio frequency transmitter/receiver, an infrared port, a USB connection, or other interfaces for connecting computing device 162 to other computing devices. Communication connection(s) 176 may include a wired connection or a wireless connection. Communication connection(s) 176 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 162 may include input device(s) 174 such as keyboard, mouse, pen, voice input device, touch input device, infrared cameras, video input devices, and/or any other input device. Output device(s) 172 such as one or more displays, speakers, printers, and/or any other output device may also be included in device 162. Input device(s) 174 and output device(s) 172 may be connected to device 162 via a wired connection, wireless connection, or any combination thereof. In one embodiment, an input device or an output device from another computing device may be used as input device(s) 174 or output device(s) 172 for computing device 162.

Components of computing device 162 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 162 may be interconnected by a network. For example, memory 168 may be comprised of multiple physical memory units located in different physical locations interconnected by a network.

Those skilled in the art will realize that storage devices utilized to store computer readable instructions may be distributed across a network. For example, a computing device 180 accessible via network 178 may store computer readable instructions to implement one or more embodiments provided herein. Computing device 162 may access computing device 180 and download a part or all of the computer readable instructions for execution. Alternatively, computing device 162 may download pieces of the computer readable instructions, as needed, or some instructions may be executed at computing device 162 and some at computing device 180.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of representing a software architecture, comprising:
representing the software architecture as a node set comprising:
a node category set comprising at least one node category;
a node set comprising at least one node representing a software architecture element and associated with at least one node category;
a link category set comprising at least one link category; and
a link set comprising at least one link between at least two nodes and associated with at least one link category.

2. The method of claim 1, the node category set comprising:
a class node category;
a function node category;
a parameter node category;
a work item node category;
an assembly node category;
a library node category;
a person node category;
a query node category;
a database node category; and
a service node category.

3. The method of claim 1, the node set comprising at least one performable action involving at least one node.

4. The method of claim 3, at least one performable action comprising at least one node criterion specifying nodes with which the action is involved.

5. The method of claim 3, the node set comprising at least one provider capable of performing at least one action involving the at least one node.

6. The method of claim 5, comprising: upon receiving a request to perform an action:
identifying a provider capable of performing the action, and
performing the action involving the at least one node through the provider.

7. The method of claim 1, comprising: upon receiving a request to transform the software architecture, transforming at least one node of the node set.

8. The method of claim 7:
the request comprising detecting an update of the software architecture; and
the transforming comprising: transforming the node set to reflect the update of the software architecture.

9. The method of claim 1, comprising: upon receiving a request to render at least a portion of the software architecture, rendering at least one node of the node set.

10. The method of claim 9, the rendering comprising: rendering the at least one node of the node set as a hierarchical data set.

11. The method of claim 9:
the node set comprising at least one visual layout specifying a visual configuration of at least one node of the node set;
the request specifying at least one visual layout for rendering the portion of the software architecture; and
the rendering comprising: visually rendering the at least one node of the node set according to the at least one specified visual layout.

12. A system for representing a software architecture, comprising:
a software architecture representing component configured to represent the software architecture as a node set comprising:
a node category set comprising at least one node category;
a node set comprising at least one node representing a software architecture element and associated with at least one node category;
a link category set comprising at least one link category; and
a link set comprising at least one link between at least two nodes and associated with at least one link category.

13. The system of claim 12:
the node set comprising at least one performable action involving at least one node; and
the system comprising at least one provider capable of performing at least one action involving the at least one node.

14. The system of claim 13, comprising:
an action performing component configured, upon receiving a request to perform an action, to:
identify a provider capable of performing the action, and
perform the action involving the at least one node through the provider.

15. The system of claim 13, comprising: a custom provider associating component configured, upon receiving a custom provider, to include the custom provider in the node set.

16. The system of claim 12, comprising: at least one transforming component configured, upon receiving a request to transform the software architecture, to transform at least one node of the node set.

17. The system of claim 12, comprising: at least one rendering component configured, upon receiving a request to render at least a portion of the software architecture, to render at least one node of the node set.

18. The system of claim 17, at least one rendering component configured to render the at least one node of the node set as a hierarchical data set.

19. The system of claim 17:
the node set comprising at least one visual layout specifying a visual configuration of at least one node of the node set;
the request specifying at least one visual layout for rendering the portion of the software architecture; and
at least one rendering component configured to visually render the at least one node of the node set according to the at least one specified visual layout.

20. A system for representing a software architecture, comprising:
a software architecture representing component configured to represent the software architecture as a node set comprising:
a node category set comprising at least one node category;
a node set comprising at least one node representing a software architecture element and associated with at least one node category;
a link category set comprising at least one link category;
a link set comprising at least one link between at least two nodes and associated with at least one link category;
at least one performable action involving at least one node; and
at least one visual layout specifying a visual configuration of at least one node of the node set;
at least one provider capable of performing at least one action involving at least one node;
an action performing component configured, upon receiving a request to perform an action, to:
identify a provider capable of performing the action, and
perform the action involving the at least one node through the provider;
a custom provider associating component configured, upon receiving a custom provider, to include the custom provider in the node set;
at least one transforming component configured, upon receiving a request to transform the software architecture, to transform at least one node of the node set;
at least one hierarchical rendering component configured, upon receiving a request to render at least a portion of the software architecture, to render at least one node of the node set as a hierarchical data set; and
at least one visual rendering component configured, upon receiving a request to render at least a portion of the software architecture and specifying at least one visual layout, to visually render the at least one node of the node set according to the at least one specified visual layout.
